(19) United States
(12) Patent Application Publication
(10) Pub. No.: US 2025/0315701 A1
(43) Pub. Date: Oct. 9, 2025

(54) DEVICE AND COMPUTER IMPLEMENTED DATA STRUCTURES AND METHODS FOR EXPLAINING AN ANSWER OF A SIMILARITY QUERY AND FOR TRAINING A MODEL FOR EXPLAINING AN ANSWER OF A SIMILARITY QUERY

(71) Applicant: Robert Bosch GmbH, Stuttgart (DE)

(72) Inventors: Cuong Xuan Chu, Heilbronn (DE); Daniel Fernando Daza Cruz, Leiden (NL); Daria Stepanova, Leonberg (DE); Trung Kien Tran, Stuttgart (DE)

(21) Appl. No.: 19/092,257

(22) Filed: Mar. 27, 2025

(30) Foreign Application Priority Data
Apr. 3, 2024 (DE) 10 2024 203 065.1

(51) Int. Cl. G06N 5/045

(52) U.S. Cl. CPC G06N 5/045

(57) ABSTRACT

A method for explaining an answer of a similarity query. A knowledge graph includes nodes including first and second nodes, edges that represent relations between pairs of nodes, and attributes that are associated in the knowledge graph with at least one edge or with at least one node. The similarity query includes the first node and the second node. The method includes providing embeddings of the first and second node of the similarity query, and providing an answer to the similarity query, the answer including a distance between the first node and the second node; determining an output of a model, the model being configured for determining the output for explaining the answer to the similarity query depending on the embeddings of the first and second nodes, and the attributes, the output including at least one value that indicates the contribution of one of the attributes to the answer.

### CROSS REFERENCE

The present application claims the benefit under 35 U.S.C. § 119 of German Patent Application No. DE 10 2024 203 065.1 filed on Apr. 3, 2024, which is expressly incorporated herein by reference in its entirety.

### FIELD

The present invention concerns a device and computer implemented data structures and methods for explaining an answer of a similarity query and for training a model for explaining an answer of a similarity query.

### BACKGROUND INFORMATION

Knowledge graphs may be used for providing an answer of a similarity query.

### SUMMARY

According to the present invention, a device, computer implemented data structures, and methods explain the answer of a similarity query and provide favorable properties.

According to an example embodiment of the present invention, first, a model, in particular an output of a graph neural network that the model comprises, for explaining the answer relies on embeddings that capture various aspects of an entity of a knowledge graph that is used to answer the query and that go beyond the aspects explicitly stated in the knowledge graph.

This is particularly favorable in case of an incomplete knowledge graph or noise in the knowledge graph. The knowledge graph may in incomplete due to missing links or entity attributes. The noise the knowledge graph contains may be introduced during the construction of the knowledge graph.

The ability of the model, in particular of the graph neural network, to generalize enables them to infer missing links, while maintaining robustness to noise in the knowledge graph.

According to an example embodiment of the present invention, a computer implemented method for explaining an answer of a similarity query, wherein a knowledge graph comprises nodes including a first node and a second node, wherein the knowledge graph comprises edges that represent relations between pairs of nodes, wherein the knowledge graph comprises attributes that are associated in the knowledge graph with at least one edge or with at least one node of the knowledge graph, wherein the similarity query comprises the first node and the second node, and the method comprises providing an embedding of the first node of the similarity query and providing an embedding of the second node of the similarity query, and providing an answer to the similarity query, wherein the answer comprises a distance between the first node and the second node, determining an output of a model, wherein the model is configured for determining the output for explaining the answer to the similarity query depending on the embedding of the first node, the embedding of the second node and the attributes, wherein the output comprises at least one value that indicates the contribution of one of the attributes to the answer.

According to an example embodiment of the present invention, the method preferably comprises determining the output to indicate how much and/or in what direction the at least one of the attributes contributes to the answer.

According to an example of the present invention, the attributes comprise at least one attribute that represents an edge of the knowledge graph or a value associated in the knowledge graph to an edge or a node of the knowledge graph.

The embeddings of the first node and of the second node may be pre-determined or read from a storage. Providing the embedding of the first node may comprise determining the embedding of the first node with an encoder depending on the first node and/or at least one other node in a neighborhood of the first node and/or at least one edge in the neighborhood, and/or at least one attribute in the neighborhood, wherein providing the embedding of the second node comprises determining the embedding of the second node with the encoder depending on the second node and/or at least one other node in the neighborhood, and/or at least one edge in the neighborhood, and/or at least one attribute in the neighborhood.

According to an example of the present invention, the nodes of the knowledge graph represent different production cells for manufacturing a workpiece or different workpieces, and/or wherein the nodes of the knowledge graph represent different operations that can be executed for manufacturing a workpiece or different workpieces, wherein the edges of the knowledge graph represent relations between pairs of production cells, pairs of operations or between a production cell and an operation, in particular a relation indicating that production cells that are linked to each other with the relation are interchangeable, or a relation indicating that operations that are linked to another with the relation are interchangeable, and the attributes represent the relation or a property, in particular a production time, associated with the relation or the production cell or the operation in the knowledge graph.

The method may comprise receiving the similarity query from a human machine interface or a machine to machine interface, wherein the first node represents a first production cell for executing an operation on the workpiece, providing the answer, sending the answer and the output that indicates the contribution of at least one of the attributes to the answer to a human machine interface or a machine to machine interface for operating, wherein the second node represents a second production cell for executing the operation on the workpiece, and wherein the at least one attribute indicates the property of the first production cell and/or the second production cell.

The method may comprise controlling the second production cell for executing the operation on the workpiece, in particular if the first production cell is out of order, for example due to a defect of the first production cell or due to maintenance work, based on the answer of the similarity query and on the output that indicates the contribution of at least one of the attributes to the answer, and based on a list, in particular a list specifying conditions, values, or ranges of the answer of the similarity query and of the output to be met.

According to an example embodiment of the present invention, a computer implemented method for training a model for explaining an answer of a similarity query, wherein a knowledge graph comprises nodes including a first node and a second node, wherein the knowledge graph comprises edges that represent relations between pairs of nodes, wherein the knowledge graph comprises attributes that are associated in the knowledge graph with at least one edge or with at least one node of the knowledge graph, wherein the similarity query comprises the first node and the second node, wherein the answer comprises a distance between the first node and the second node, and the method comprises providing the similarity query, providing the answer, providing an embedding of the first node, providing an embedding of the second node, determining an output of the model, wherein the model is configured for determining the output for explaining the answer to the similarity query depending on the first node, the second node, the embedding of the first node, the embedding of the second node and the attributes, wherein the output comprises at least one value that indicates the contribution of one of the attributes to the answer, wherein providing the answer comprises determining a similarity between the first node and the second node depending on the first node, the second node, the embedding of the first node, the embedding of the second node and the attributes, wherein the method comprises determining an estimated similarity between the first node and the second node depending on the output for explaining the answer to the similarity query, and training the model depending on a difference between the similarity and the estimated similarity.

Determining the estimated similarity may comprise determining a, in particular normalized, sum of the values of the output.

According to the present invention, a device may comprise at least one processor and at least one memory, wherein the at least one memory comprises instructions that, when executed by the at least one processor, cause the device to execute a method for explaining an answer of a similarity query or for training, according to the present invention.

According to an example embodiment of the present invention, a computer implemented data structure may comprise at least one data field for explaining an answer of a similarity query, at least one data field for the similarity query, wherein the similarity query comprises a first node of a knowledge graph, at least one data field for the answer, wherein the answer comprises a second node of the knowledge graph, at least one data field for an embedding of the first node, at least one data field for an embedding of the second node, at least one data field for attributes that are associated in the knowledge graph with at least one edge or at least one node of the knowledge graph, at least one data field for an output of a model, in particular an output of a graph neural network that the model comprises, for explaining the answer to the similarity query depending on the first node, the second node, the embedding of the first node, the embedding of the second node and the attributes, wherein the output comprises at least one value that indicates the contribution of one of the attributes to the answer.

According to an example embodiment of the present invention, the computer implemented data structure may comprise at least one data field for a similarity between the first node and the second node that is determined depending on the first node, the second node, the embedding of the first node, the embedding of the second node and the attributes, at least one data field for an estimated similarity between the first node and the second node that is determined depending on the output for explaining the answer to the similarity query, and at least one data field for a difference between the similarity and the estimated similarity.

Further exemplary embodiments of the present invention are derived from the following description and the figures.

### BRIEF DESCRIPTION OF THE DRAWINGS

FIG. 1 schematically depicts an overview of an approach for determining similarities and explanations for a specific pair of nodes u and v of a knowledge graph, according to an example embodiment of the present invention.

FIG. 2 schematically depicts an overview of an iterative algorithm for optimizing a model, in particular an encoder and an explainer module of the model, according to an example embodiment of the present invention.

FIG. 3 depicts a flow chart comprising steps of a method for explaining an answer of a similarity query, according to an example embodiment of the present invention.

FIG. 4 depicts a flow chart comprising steps of a method for training a model for explaining the answer of the similarity query, according to an example embodiment of the present invention.

FIG. 5 schematically depicts a device for executing the method for explaining the answer or for training the model, according to an example embodiment of the present invention.

FIG. 6 schematically depicts an in particular computer implemented data structure for executing the method for explaining the answer or for training the model, according to an example embodiment of the present invention.

### DETAILED DESCRIPTION OF EXAMPLE EMBODIMENTS

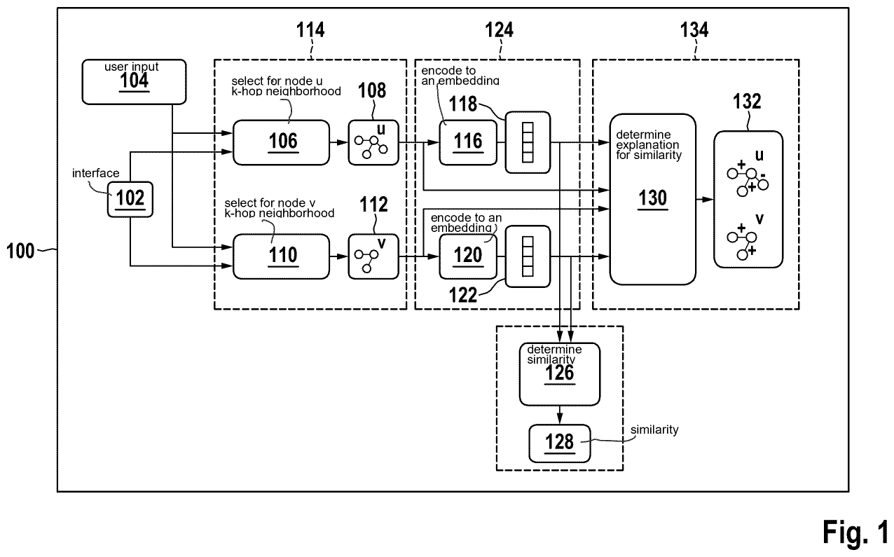

FIG. 1 schematically depicts an overview of an approach for determining similarities and explanations for a specific pair of nodes u and v of a knowledge graph.

The knowledge graph is a tuple G=(V; R; E; X), with V a set of n nodes v, R a set of relations, E a set of edges of the form (h; r; t) with h; t∈V and r∈R, and X a matrix of node features.

This means, an edge in the knowledge graph represents a relation beteween pairs of nodes of the knowledge graph.

The nodes of the knowledge graph G may represent different production cells for manufacturing a workpiece or different workpieces.

The nodes of the knowledge graph G may represent different operations that can be executed for manufacturing a workpiece or different workpieces.

The edges of the knowledge graph G may represent relations between pairs of production cells, pairs of operations or between a production cell and an operation. A relation may indicate that production cells that are linked to each other with the relation are interchangeable. A relation may indicate that operations that are linked to another with the relation are interchangeable.

A k-hop neighborhood of a node u is defined as the set of edges (h; r; t)∈E involving nodes whose shortest path distance to u is k or less. Formally, the k-hop neighborhood of u is the set {(h; r; t)∈E sp(u; h)≤k∧sp u; t)≤k}, where sp is the shortest path distance.

Graph embeddings are vector representations of nodes and relations in a space [symbol] . u denotes an embedding of a node u in V.

The problem of similarity search on G comprises of ranking the nodes in V according to their similarity to a query node u∈V.

A similarity query in this context comprises the query node. This means, the similarity query comprises a node of the knowledge graph. The similarity query may be a text string comprising the query node.

A distance function between nodes is a binary function of nodes in the graph that returns a scalar describing how close they are according to a certain criterion.

This means, an answer to the similarity query comprises a distance between a node of the knowledge graph and the query node, e.g., the scalar, that describes how close the node of the knowledge graph is to the query node. The answer may be a text string comprising the answer.

Formally, a distance function between nodes defines a mapping d: V×V→ [symbol] .

A simple example is the function d(u; v)=|deg(u)−deg(v)|, where deg(·) returns the degree of a node. With this function, there is a small distance between nodes of similar degrees.

According to an exemplary mechanism, embeddings of nodes in the knowledge graph capture similarities between nodes and provide explanations for the similarity.

This mechanism is implemented for example via a model 100 that comprises an interface 102 to the knowledge graph G and a user input 104. The model 100 is configured for providing an explanation for the similarity between nodes u and v from the knowledge graph G.

The interface 102 is configured in the example to provide the nodes u and v. the interface 102 may be configured to provide a size k of a neighborhood of the nodes that shall be considered for determining the similarity and/or the explanation. The size k may be a predetermined constant.

The model 100 is configured to select, in a step 106, for the node u the k-hop neighborhood 108. The model 100 is configured to select, in a step 110, for the node v the k-hop neighborhood 112.

According to an example, the model 100 comprises a selector 114 that is configured to select the respective k-hop neighborhood for the respective node.

The model 100 is configured to encode, in a step 116, the node u and the k-hop neighborhood 108 of the node u to an embedding 118 of the node u.

The model 100 is configured to encode, in a step 120, the node v and the k-hop neighborhood 112 of the node v to an embedding 122 of the node v.

According to an example, the model 100 comprises an encoder 124. The encoder 124 is configured to process input data. The encoder 124 is configured to encode the input data.

The input data for example comprises the nodes u and v, and the k-hop neighborhood of the node u and the k-hop neighborhood of the node v.

The input data may additionally comprise at least one attribute that the knowledge graph G assigns to the node u, the node v, or any member of the k-hop neighborhood of the node u or of the k-hop neighborhood of the node v. Member of the k-hop neighborhood in this context refers to an edge or a node of the knowledge graph G.

An attribute may represent a relation or a property, in particular a production time, associated with the relation or the production cell or the operation in the knowledge graph G.

The input data may comprise a list of attributes (a₁; a₂; . . . ; a_{A}). For example, an attribute aᵢ represents a single edge in the k-hop neighborhood of the node u or the node v. The knowledge graph G may comprise numerical attributes that are associated to a node or an edge of the knowledge graph G as well. The attribute aᵢ may be a numerical attribute that is assigned in the knowledge graph to the node u, the node v, or any member of the k-hop neighborhood of the node u or of the k-hop neighborhood of the node v.

The task of the encoder 124 is to compute node embeddings useful for answering similarity search queries. According to an example, the encoder 124 is defined as a function f_{Θ}:V→ [symbol] where Θ are parameters to be optimized.

According to an example, f_{θ} is implemented using a graph neural network (GNN) that takes as input a node u and its k-hop neighborhood in the knowledge graph, and outputs the embedding u∈ [symbol] .

This means the GNN is a neural network that is configured to map a node of the knowledge graph and a neighborhood of the node in the knowledge graph to an embedding.

The model 100 is configured to determine, in a step 126, a similarity 128 between the node u and the node v, depending on the embedding 118 of the node u and the k-hop neighborhood 108 of the node u and depending on the embedding 122 of the node v and the k-hop neighborhood 112 of the node V.

According to an example, the encoder 124 provides the embeddings u and v. According to an example, the similarities between nodes u and v are determined depending on the embeddings u and v. According to an example, the similarity 128 is computed as the dot product u^{T}v of the embeddings u and V.

The model 100 is configured to determine, in a step 130, an explanation 132 for the similarity 128 between the node u and the node v.

According to an example, the model 100 comprises an explainer 134 that is configured to output the explanation 132 for the similarity 128 between the node u and the node v.

According to an example, the explainer 134 takes as input the nodes u and v, the k-hop neighborhood of the node u and the k-hop neighborhood of the node v, and the embedding u of the node u and the embedding v of the node V.

According to an example, the explainer 134 outputs at least one label. the labels indicate the contribution of the attribute that is associated with the at least one label to the answer. The output may comprise values, wherein a respective value indicates a respective label.

This means, the output of the explainer 134 comprises at least one value that indicates the contribution of one of the attributes to the answer.

The at least one label is associated for example with the node u or the node v or a member of the k-hop neighborhood of the node u, or a member of the k-hop neighborhood of the node v.

The explainer 134 is for example a neural network g_{Φ} that outputs a list of explanation labels g_{Φ}(u, v)=(e₁, . . . , e_{A}) where each eᵢ∈(−1,1) is an explanation label assigned to each attribute di. The value g_{Φ}(u, v)=eᵢ indicates how much and in what direction (positive or negative) the attribute aᵢ contributes to the dot product u^{T}v of the embeddings u and v.

The model 100 can be employed to answer similarity queries. Given a query node u, a ranking for a similarity query is produced depending on the input data for example by computing the dot product u^{T}v of the embeddings u and v for v∈V.

The model 100 can be employed to provide an explanation for the answer to the similarity query. For example, the explainer 134 is executed to assign explanation labels to parts of the input data responsible for increasing or decreasing the dot product u^{T}v of the embeddings u and V.

The dot product u^{T}v of the embeddings u and v is an example for an operation to determine a similarity score for the similarity between the node u or the node v. Other operations on the embeddings u and v may be used in order to determine the similarity score for the similarity between the node u or the node v.

The illustration in FIG. 1 refers to a pair of nodes u and v. The model 100 may be configured to compute similarities and explanations between node u and one or more other nodes in the knowledge graph G.

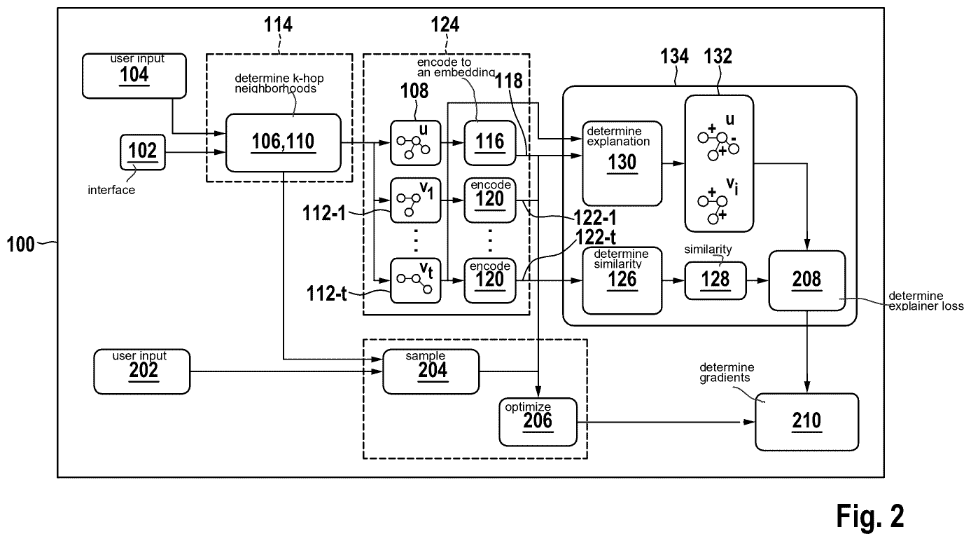

FIG. 2 schematically depicts an overview of an iterative algorithm for optimizing the model 100, in particular the encoder 124 and the explainer 134 of the model 100. The selector 114 is configured to select, in the step 106, the k*hop neighborhood 108 for the node u and to select in the step 110, a plurality of k-hop neighborhoods 112-1, . . . , 112-t for respective nodes v₁, . . . , vₜ. The encoder 124 is configured to determine, in the step 116, the embedding 118 of the node u depending on the k-hop neighborhood 108 of the node u. the encoder 124 is configured to determine, in the step 120, a plurality of embeddings 122-1, . . . , 122-t for the respective nodes v₁, . . . , vₜ depending on the respective k-hop neighborhood 112-1, . . . , 112-t of the respective node v₁, . . . , vₜ.

The model 100 is configured to determine, in the step 126, a respective similarity 128 between the node u and the respective node vᵢ, depending on the embedding 118 of the node u and the k-hop neighborhood 108 of the node u and depending on the respective embedding 122-ᵢ of the respective node vᵢ and the k-hop neighborhood 112-ᵢ of the respective node vᵢ.

The model 100 is configured to determine, in the step 130, a respective explanation 132 for the similarity 128 between the node u and the respective node vᵢ depending on the node u, the k-hop neighborhood of the node u, and the respective embedding 122-i of the respective node vᵢ and the k-hop neighborhood 112_i of the respective node vᵢ.

The model 100 in the example contains neural networks in the encoder 124 and explainer 134. The parameters Θ of the encoder 124 and/or the parameters Φ of the explainer 134 may be optimized in particular before deployment.

According to an example, the encoder 124 and/or the explainer 134 are optimized by iteratively adjusting the parameters of the neural networks using gradient descent on a specific loss function.

In order to optimize the encoder 124, the loss function comprises a ranking loss. The ranking loss enforces pairwise distances between node embeddings to follow distance relations computed with a distance function. An example for the distance function is the degree distance d(u, v).

According to an example, the model 100 comprises a user input 202 that is configured for receiving the distance function.

According to an example, optimizing may comprise, in a step 204, sampling, for a node v from the nodes v∈V in the knowledge graph G, a set T(uᵢ)_{i=1, . . . ,t} of t target nodes uᵢ, determining their respective distance to the node v, and arranging the t target nodes into an ordered list T^{v}(u₁, . . . , uₜ) of ascending distance from the node v such that d(v, u₁)<d(v, u₂)<. . . <d(v, uₜ).

According to an example, optimizing may comprise, in a step 206, and denoting the i-th element of the list T^{v} as Tᵢ^{v}, determining a ranking loss L_{R}(v) for the nodes v

$${L}_{R} ( v ) = {\sum }_{i = 1}^{t} {\sum }_{j = i + 1}^{t} {\hat{d} ( {f}_{Θ} ( v ) , {f}_{Θ} ( {T}_{i}^{v} ) )}^{2} + exp ( - \hat{d} ( {f}_{Θ} ( v ) , {f}_{Θ} ( {T}_{j}^{v} ) ) )$$

where \hat{d} is a distance function over embeddings, e.g., the L2 Euclidean distance d(u, v)=∥u−v∥². Instead of the L2 Euclidean distance, another distance function may be used.

This ranking loss L_{R}(v) encourages that the distances in the embedding space of the embeddings will preserve the relations included by the distance function between the nodes, such as the degree distance.

According to an example, optimizing may comprise, in a step 208, determining an explainer loss L_{E}.

In the case of the explainer 134, the explainer 134 is for example optimized so that a sum of the explanation labels it produces adds up to the dot product u^{T}v of the embeddings u and v between the pair of nodes u and v. An estimated dot product ŝ_{Θ}(u, v) that results from the explanation labels eᵢ is for example defined as the normalized sum of labels:

$${\hat{s}}_{Φ} ( u , v ) = \frac{1}{A} {\sum }_{i} {{g}_{Φ} ( u , v )}_{i}$$

The explainer 134 may be optimized so that the normalized sum of labels is equal to the dot product u^{T}v of the embeddings u and v using a squared error loss as explainer loss:

$${L}_{E} ( u , v ) = {( {u}^{T} v - {\hat{s}}_{Φ} ( u , v ) )}^{2}$$

The optimization may comprise determining, in a step 210, the gradients of the loss functions L_{R}(v) and L_{E}(u, v) with respect to the parameters Θ of the encoder 124 and the parameters Φ of the explainer 134, and updating the parameters Θ of the encoder 124 and the parameters Φ of the explainer 134 using gradient descent, e.g., to minimize the loss functions L_{R}(v) and L_{E}(u, v).

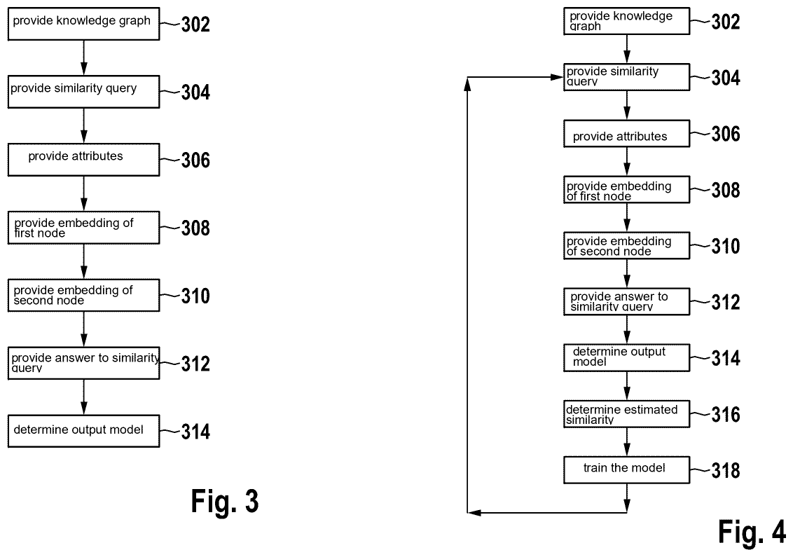

FIG. 3 depicts a flow chart comprising steps of a computer implemented method for explaining an answer of a similarity query.

The method comprises a step 302.

In the step 302 comprises providing a knowledge graph. For example, the knowledge graph G is provided.

The method comprises a step 304.

In the step 304, the similarity query is provided.

The similarity query comprises a first node of a knowledge graph. The first node is for example the node u of the knowledge graph G. The similarity query comprises a second node of a knowledge graph. The second node is for example the node v of the knowledge graph G.

The similarity query may be received from a human machine interface, e.g., the user interface, or a machine to machine interface.

The first node may represent a first production cell for executing an operation on a workpiece. The second node may represent a second production cell for executing the operation on the workpiece.

The method comprises a step 306.

In the step 306, attributes that are associated in the knowledge graph with at least one edge or at least one node of the knowledge graph are provided. The attributes may comprise at least one attribute that represents an edge of the knowledge graph or a value associated in the knowledge graph to an edge or a node of the knowledge graph.

For example, attributes of a k-hop neighborhood of the first node are provided. For example, attributes of a k-hop neighborhood of the second node are provided.

According to an example, the attributes (a₁; a₂; . . . ; a_{A}) are provided. According to an example, at least one attribute aᵢ that represents a single edge in the k-hop neighborhood of the node u or in the k-hop neighborhood of the node v is provided.

At least one attribute may indicate the property of the first production cell. At least one attribute may indicate the property of the second production cell. One attribute may indicate the property of the first production cell and the second production cell.

The method comprises a step 308.

In the step 308, an embedding of the first node is provided. For example, the embedding 118 of the node u is provided.

Providing the embedding of the first node may comprise determining the embedding of the first node with the encoder 124 depending on the first node. For example the embedding f_{Θ}(u) ist determined.

Providing the embedding of the first node may comprise determining the embedding of the first node with the encoder 124 depending on at least one other node in a neighborhood of the first node.

Providing the embedding of the first node may comprise determining the embedding of the first node with the encoder 124 depending on the first node and at least one other node in a neighborhood of the first node.

Providing the embedding of the first node may comprise determining the embedding of the first node with the encoder 124 depending on at least one edge in the neighborhood.

Providing the embedding of the first node may comprise determining the embedding of the first node with the encoder 124 depending on at least one attribute in the neighborhood of the first node.

The method comprises a step 310.

In the step 310, an embedding of the second node is provided. For example, the embedding 122 of the node v is provided. For example the embedding f_{Θ}(u) ist determined.

Providing the embedding of the second node may comprise determining the embedding of the second node with the encoder 124 depending on the second node.

Providing the embedding of the second node may comprise determining the embedding of the second node with the encoder 124 depending on at least one other node in a neighborhood of the second node.

Providing the embedding of the second node may comprise determining the embedding of the second node with the encoder 124 depending on the second node and at least one other node in a neighborhood of the second node.

Providing the embedding of the second node may comprise determining the embedding of the second node with the encoder 124 depending on at least one edge in the neighborhood of the second node.

Providing the embedding of the second node may comprise determining the embedding of the second node with the encoder 124 depending on at least one attribute in the neighborhood.

The method may comprise determining the embeddings of a plurality of nodes including the first node and the second node and storing the embeddings.

The method comprises a step 312.

In the step 312 the answer to the similarity query is provided.

The answer comprises the similarity between the first node and the second node.

According to an example, the similarity between the first node and the second node is determined depending on the first node, the second node, the embedding of the first node, the embedding of the second node and the attributes. For example, the dot product u^{T}v of the embeddings u and v is determined to indicate the similarity the first node u and the second node V.

The answer is for example sent via the machine to machine interface.

The answer is for example output via the human machine interface.

The method comprises a step 314.

In the step 314 an output of the model 100 is determined depending on the first node, the second node, the embedding of the first node, the embedding of the second node and the attributes.

According to an example, the output of the explainer 134, e.g., of the neural network g_{Θ}(u, v)=(e₁, . . . , e_{A}) is determined. The output comprises the explanation, e.g., explanation labels e₁, . . . , e_{A}, for explaining the answer to the similarity query. The output comprises at least one value that indicates the contribution of one of the attributes to the answer.

The step 314 may comprise determining the output to indicate how much and/or in what direction the at least one of the attributes contributes to the answer.

The output is for example sent via the machine to machine interface.

The output is for example output via the human machine interface.

The method may comprise determining output of the model 100 for the first node and the second node depending on the respective embedding that has been previously determined and stored. This means, it is not necessary to determine the similarity between the nodes in order to determine the explanation from the previously determined embeddings of the first node and the second node.

In this case, the output for explaining the answer to the similarity query is determined depending on the first node and the second node in the sense that the embedding of the first node and the embedding of the second node are selected or identified depending on the first node and the second node.

The method optionally comprises controlling the second production cell instead of the first production cell for executing the operation on the workpiece.

According to an example, the second production cell is controlled for executing of the operation on the workpiece if the first production cell is out of order. The first production cell is for example out of order due to a defect of the first production cell or due to maintenance work.

For example, the second production cell is controlled for executing the operation on the workpiece based on
the answer of the similarity query,
on the output that indicates the contribution of at least one of the attributes to the answer,
based on a list, in particular a list specifying conditions, values, or ranges of the answer of the similarity query and of the output to be met.

FIG. 4 depicts a flow chart comprising steps of a computer implemented method for training the model 100 for explaining the answer of the similarity query.

The method for training the model 100 comprises for example, training the encoder 124 and/or training the explainer 134.

The method for training the model 100 comprises the steps 302 to 314 of the method for explaining the answer of the similarity query.

The method for training additionally comprises a step 316.

The step 316 comprises determining an estimated similarity between the first node and the second node depending on the output for explaining the answer to the similarity query.

The estimated similarity may depend on a sum, in particular a normalized sum, of the values of the output of the model 100. For example, for the first node u and the second node v, the estimated similarity is the normalized sum of labels:

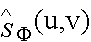

The method for training comprises a step 318.

The step 318 comprises training the model 100 depending on a difference between the similarity and the estimated similarity. According to an example, the loss functions L_{R}(v) and L_{E}(u, v) are used in the training. Training the model 100 may comprise minimizing the loss functions L_{R}(v) and L_{E}(u, v).

The training may comprise executing the steps 304 to 318 in iterations. The parameters Θ, Φ may be determined, e.g. with a gradient descent based on the loss functions L_{R}(v) and L_{E}(u, v). The parameters Θ, Φ may be updated between two iterations.

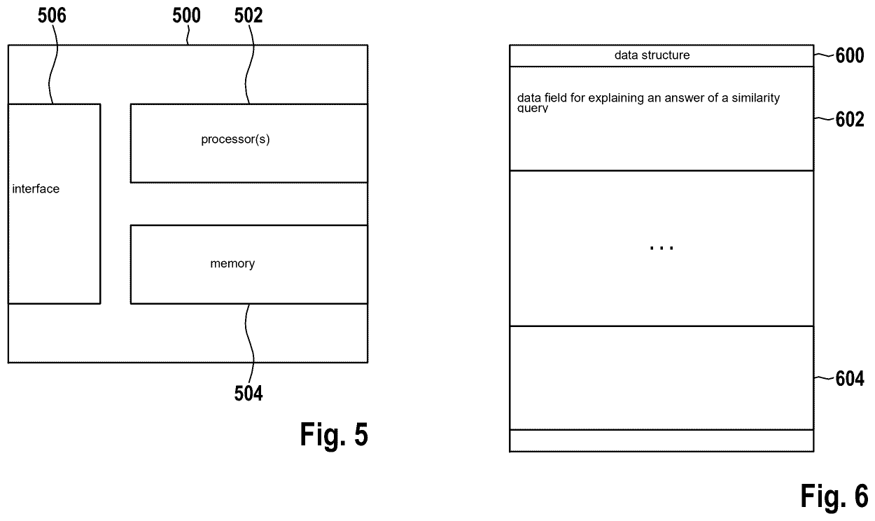

FIG. 5 schematically depicts a device 500 for executing the method for explaining the answer or for training the model 100. The device 500 comprises an interface 506. The interface 506 may comprise the human machine interface or the machine to machine interface.

The device 500 comprises at least one processor 502 and at least one memory 504. The at least one memory 504 in the example comprises non-transitory and volatile memory.

According to an example, the at least one memory 504 comprises instructions that, when executed by the at least one processor 502, cause the device 500 to execute the method for explaining the answer of the similarity query. According to an example, the at least one memory 504 comprises instructions that, when executed by the at least one processor 502, cause the device 500 to execute the method for training.

FIG. 6 schematically depicts an in particular computer implemented data structure 600 for executing the method for explaining the answer or for training the model. The data structure 600 comprises a plurality of data fields 602.

The data structure 600 comprises at least one data field 602 for explaining an answer of a similarity query.

The data structure 600 comprises at least one data field 602 for the similarity query, wherein the similarity query comprises a first node of a knowledge graph.

The data structure 600 comprises at least one data field 602 for the answer, wherein the answer comprises a second node of the knowledge graph.

The data structure 600 comprises at least one data field 602 for an embedding of the first node, at least one data field 602 for an embedding of the second node, at least one data field 602 for attributes that are associated in the knowledge graph with at least one edge or at least one node of the knowledge graph.

The data structure 600 comprises at least one data field 602 for an output of the model 100, in particular an output of a graph neural network that the model 100 comprises. The output comprises at least one value that indicates the contribution of one of the attributes to the answer.

The data structure 600 may additionally comprise at least one data field 602 for a similarity between the first node and the second node that is determined depending on the first node, the second node, the embedding of the first node, the embedding of the second node and the attributes.

The data structure 600 may additionally comprise at least one data field 602 for an estimated similarity between the first node and the second node that is determined depending on the output for explaining the answer to the similarity query.

the data structure 600 may additionally comprise at least one data field 602 for a difference between the similarity and the estimated similarity.

What is claimed is:

1. A computer implemented method for explaining an answer of a similarity query, wherein a knowledge graph includes nodes including a first node and a second node, edges that represent relations between pairs of nodes, and attributes that are associated in the knowledge graph with at least one edge or with at least one node of the knowledge graph, wherein the similarity query includes the first node and the second node, and wherein the method comprises the following steps:
providing an embedding of the first node of the similarity query;
providing an embedding of the second node of the similarity query;
providing an answer to the similarity query, wherein the answer includes a distance between the first node and the second node; and
determining an output of a model, wherein the model is configured to determine the output for explaining the answer to the similarity query depending on the embedding of the first node, the embedding of the second node, and the attributes, wherein the output includes at least one value that indicates a contribution of at least one of the attributes to the answer.

2. The method according to claim 1, further comprising:
determining the output to indicate how much and/or in what direction the at least one of the attributes contributes to the answer.

3. The method according to claim 1, wherein the attributes include at least one attribute that represents an edge of the knowledge graph, or a value associated in the knowledge graph to an edge or a node of the knowledge graph.

4. The method according to claim 1, wherein the providing of the embedding of the first node includes determining the embedding of the first node with an encoder depending on: (i) the first node and/or (ii) at least one other node in a neighborhood of the first node and/or (iii) at least one edge in the neighborhood, and/or (iv) at least one attribute in the neighborhood, and wherein the providing of the embedding of the second node includes determining the embedding of the second node with the encoder depending on: (i) the second node and/or (ii) at least one other node in the neighborhood, and/or (iii) at least one edge in the neighborhood, and/or (iv) at least one attribute in the neighborhood.

5. The method according to claim 1, wherein:
the nodes of the knowledge graph represent different production cells for manufacturing a workpiece or different workpieces, and/or the nodes of the knowledge graph represent different operations that can be executed for manufacturing a workpiece or different workpieces,
the edges of the knowledge graph represent relations: (i) between pairs of production cells, or pairs of operations or (ii) between a production cell and an operation, wherein: (i) a relation indicates that production cells that are linked to each other with the relation are interchangeable, or (ii) a relation indicates that operations that are linked to another with the relation are interchangeable, and
the attributes represent the relation or a property, including a production time, associated with the relation or the production cell or the operation in the knowledge graph.

6. The method according to claim 5, further comprising:
receiving the similarity query from a human machine interface or a machine to machine interface, wherein the first node represents a first production cell for executing an operation on the workpiece;
providing the answer;
sending the answer and the output that indicates the contribution of at least one of the attributes to the answer to a human machine interface or a machine to machine interface for operating, wherein the second node represents a second production cell for executing the operation on the workpiece, and wherein the at least one attribute indicates the property of the first production cell and/or the second production cell.

7. The method according to claim 6, further comprising:
controlling the second production cell for executing the operation on the workpiece, when the first production cell is out of order, due to a defect of the first production cell or due to maintenance work, based on the answer of the similarity query and on the output that indicates the contribution of at least one of the attributes to the answer, and based on a list specifying conditions or values or ranges of the answer of the similarity query and of the output to be met.

8. A computer implemented method for training a model for explaining an answer of a similarity query, wherein a knowledge graph includes nodes including a first node and a second node, edges that represent relations between pairs of nodes, and attributes that are associated in the knowledge graph with at least one edge or with at least one node of the knowledge graph, wherein the similarity query includes the first node and the second node, wherein the answer includes a distance between the first node and the second node, and wherein the method comprises the following steps:
providing the similarity query;
providing the answer;
providing an embedding of the first node;
providing an embedding of the second node;
determining an output of the model, wherein the model is configured to determine the output for explaining the answer to the similarity query depending on the first node, the second node, the embedding of the first node, the embedding of the second modem and the attributes, wherein the output includes at least one value that indicates a contribution of one of the attributes to the answer;
wherein providing the answer includes determining a similarity between the first node and the second node depending on the first node, the second node, the embedding of the first node, the embedding of the second node, and the attributes;
wherein the method further comprises:
determining an estimated similarity between the first node and the second node depending on the output for explaining the answer to the similarity query, and
training the model depending on a difference between the similarity and the estimated similarity.

9. The method according to claim 8, wherein the determining of the estimated similarity includes determining a normalized sum of values of the output.

10. A device, comprising:
at least one processor; and
at least one memory, wherein the at least one memory includes instructions that, when executed by the at least one processor, cause the device to execute a method for explaining an answer of a similarity query, wherein a knowledge graph includes nodes including a first node and a second node, edges that represent relations between pairs of nodes, and attributes that are associated in the knowledge graph with at least one edge or with at least one node of the knowledge graph, wherein the similarity query includes the first node and the second node, and wherein the method comprises the following steps:
providing an embedding of the first node of the similarity query;
providing an embedding of the second node of the similarity query;
providing an answer to the similarity query, wherein the answer includes a distance between the first node and the second node; and
determining an output of a model, wherein the model is configured to determine the output for explaining the answer to the similarity query depending on the embedding of the first node, the embedding of the second node, and the attributes, wherein the output includes at least one value that indicates a contribution of at least one of the attributes to the answer.

11. A computer implemented data structure, comprising:
at least one data field for explaining an answer of a similarity query;
at least one data field for the similarity query, wherein the similarity query includes a first node of a knowledge graph;
at least one data field for the answer, wherein the answer includes a second node of the knowledge graph;
at least one data field for an embedding of the first node;
at least one data field for an embedding of the second node;
at least one data field for attributes that are associated in the knowledge graph with at least one edge or at least one node of the knowledge graph;
at least one data field for an output of a model, the output being an output of a graph neural network that the model includes, for explaining the answer to the similarity query depending on the first node, the second node, the embedding of the first node, the embedding of the second node, and the attributes, wherein the output includes at least one value that indicates the contribution of one of the attributes to the answer.

12. The computer implemented data structure according to claim 11, wherein the data structure further includes:
at least one data field for a similarity between the first node and the second node that is determined depending on the first node, the second node, the embedding of the first node, the embedding of the second node, and the attributes;
at least one data field for an estimated similarity between the first node and the second node that is determined depending on the output for explaining the answer to the similarity query; and
at least one data field for a difference between the similarity and the estimated similarity.
